(19) United States
(12) Patent Application Publication
(10) Pub. No.: US 2023/0271271 A1
(43) Pub. Date: Aug. 31, 2023

(54) EXOTHERMIC REACTION WELD METAL ASSEMBLIES AND METHODS OF USE

(71) Applicant: Hubbell Incorporated, Shelton, CT (US)

(72) Inventors: Parker David Martel, Franconia, NH (US); Carl Andrew Lindquist, Dalton, NH (US); Logan Michael Trombley, Manchester, NH (US)

(73) Assignee: Hubbell Incorporated, Shelton, CT (US)

(21) Appl. No.: 18/174,676

(22) Filed: Feb. 27, 2023

Related U.S. Application Data
(60) Provisional application No. 63/313,770, filed on Feb. 25, 2022.

(51) Int. Cl. B23K 23/00

(52) U.S. Cl. CPC B23K 23/00

(57) ABSTRACT

A weld metal assembly is provided that includes a tube containing an exothermic reaction weld metal, a metal disk, and an outer packaging having a sealed area in which the tube and the metal disk are contained.

### CROSS REFERENCE TO RELATED APPLICATIONS

This application claims benefit of U.S. Provisional Application 63/313,770 filed Feb. 25, 2022, the entire contents of which are incorporated herein by reference.

### BACKGROUND

### 1. Field of the Disclosure

The present disclosure is related to exothermic welding. More particularly, the present disclosure is related to exothermic welding assemblies and methods of use.

### 2. Description of Related Art

The use of exothermic reaction welding is known for joining various connectors and/or conductors to each other such as, but not limited to, stranded wire conductors, ground rods, connector lugs, and others.

During such welding, it is common to employ a reusable mold that has a reaction chamber in fluid communication with a weld cavity, which is positioned below the reaction chamber. In this process, portions of the components to be welded together are placed in the weld cavity. A metal disk or plug is often placed at the bottom of the reaction chamber, to temporarily seal off the passageway between weld chamber and the reaction chamber. An exothermic weld-metal is placed in the reaction chamber and, when present, onto the metal disk.

The weld-metal is ignited such that an exothermic reaction results in the reaction chamber. The weld-metal liquefies and, when present, melts the disk or plug, such that the molten material flows into the weld cavity and welds together the components within the cavity.

The raw materials required for such exothermic reaction welding include one or more of: a mold, a supply of weld metal, a supply of ignition material, a metal disk, and an ignition device. The use of these materials occurs in the field and—often times—in difficult conditions, which can increase the time necessary to install the raw materials, can result in improper welds, and other disadvantageous results.

For example, the weld metal and/or ignition material are often provided in a plastic box containing a plurality of individual plastic tubes. The box often has a shrink wrap that once removed can expose the remaining tubes of weld metal and/or ignition material to heat and humidity, which reduce the shelf life and/or reactivity of the materials. Additionally, the discs and/or ignition devices are typically packaged separately from the tubes of weld metal and, thus, are subject to being misplaced.

Accordingly, it has been determined by the present disclosure that there is a need for weld-metal assemblies and methods of use that overcome, alleviate, and/or mitigate one or more of the aforementioned and other deleterious effects of the prior art.

### SUMMARY

A weld metal assembly is provided that includes a tube containing an exothermic reaction weld metal, a metal disk, and an outer packaging having a sealed area in which the tube and the metal disk are contained.

In some embodiments either alone or together with any one or more of the aforementioned and/or after-mentioned embodiments, the assembly further includes a cap on the tube so as to contain the weld metal in the tube.

In some embodiments either alone or together with any one or more of the aforementioned and/or after-mentioned embodiments, the metal disk is removably secured to the tube and/or the cap.

In some embodiments either alone or together with any one or more of the aforementioned and/or after-mentioned embodiments, the metal disk is loose within the outer packaging.

In some embodiments either alone or together with any one or more of the aforementioned and/or after-mentioned embodiments, the assembly further includes an igniting device in the sealed area.

In some embodiments either alone or together with any one or more of the aforementioned and/or after-mentioned embodiments, the weld metal further includes an ignition material.

In some embodiments either alone or together with any one or more of the aforementioned and/or after-mentioned embodiments, the outer packaging has a feature selected from a group consisting of being vacuum sealed, being impermeable to moisture, being formed of biodegradable materials, and any combinations thereof.

In some embodiments either alone or together with any one or more of the aforementioned and/or after-mentioned embodiments, the outer packaging further includes one or more gripping tabs configured for gripping by a user to open the outer packaging.

In some embodiments either alone or together with any one or more of the aforementioned and/or after-mentioned embodiments, the one or more gripping tabs includes a pull or tear strip.

In some embodiments either alone or together with any one or more of the aforementioned and/or after-mentioned embodiments, the one or more gripping tabs include two opposing tabs that allow the user to pull the two opposing tabs apart to open the outer packaging.

In some embodiments either alone or together with any one or more of the aforementioned and/or after-mentioned embodiments, the two opposing tabs further include one or more grip enhancing structures.

In some embodiments either alone or together with any one or more of the aforementioned and/or after-mentioned embodiments, the assembly further includes product information on the outer packaging and/or in the sealed area.

In some embodiments either alone or together with any one or more of the aforementioned and/or after-mentioned embodiments, the outer packaging includes a plurality of the sealed areas, each of the plurality of the sealed areas includes the tube with the weld metal and the metal disk.

In some embodiments either alone or together with any one or more of the aforementioned and/or after-mentioned embodiments, the assembly further includes an igniting device in each of the plurality of the sealed areas.

In some embodiments either alone or together with any one or more of the aforementioned and/or after-mentioned embodiments, the outer packaging further includes a tear line between the plurality of the sealed areas.

In some embodiments either alone or together with any one or more of the aforementioned and/or after-mentioned embodiments, the outer packaging further includes two tear lines between the plurality of the sealed areas, the two tear lines defining a second area therebetween.

In some embodiments either alone or together with any one or more of the aforementioned and/or after-mentioned embodiments, the tubes are in the sealed area and the disks are in the second area.

In some embodiments either alone or together with any one or more of the aforementioned and/or after-mentioned embodiments, the igniting device is in the second area.

A method of using an exothermic reaction weld metal is also provided. The method includes opening a sealed area of an outer packaging; removing a tube containing an exothermic reaction weld metal and a metal disk from the sealed area; and using the metal disk and the weld metal to form a weld.

In some embodiments either alone or together with any one or more of the aforementioned and/or after-mentioned embodiments, the outer packaging has a plurality of the sealed areas separated by a tear line and the method further includes, prior to the opening step: separating one of the plurality of the sealed areas from the outer packaging.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is a front view of exemplary embodiments of exothermic reaction weld metal assembly according to the present disclosure;

FIG. 2 schematically illustrates an alternate exemplary embodiment of an opening tab for the assemblies of the present disclosure;

FIG. 3 is a front view of the assembly of FIG. 1;

FIG. 4 is a rear view of the assembly of FIG. 1;

FIGS. 5-7 are front views of exemplary embodiments of exothermic reaction weld metal assemblies according to the present disclosure;

FIGS. 8-9 schematically illustrates a method of using the assemblies of the present disclosure;

FIG. 10 is a side view of an exemplary embodiment of a disk retaining feature for the assemblies of the present disclosure;

FIG. 11 is a top view of the disk retaining feature of FIG. 10;

FIG. 12-14 is a sectional view of an alternate exemplary embodiment of a disk retaining feature according to the present disclosure; and

FIGS. 13-14 are side views of alternate exemplary embodiments of disk retaining features according to the present disclosure.

### DETAILED DESCRIPTION

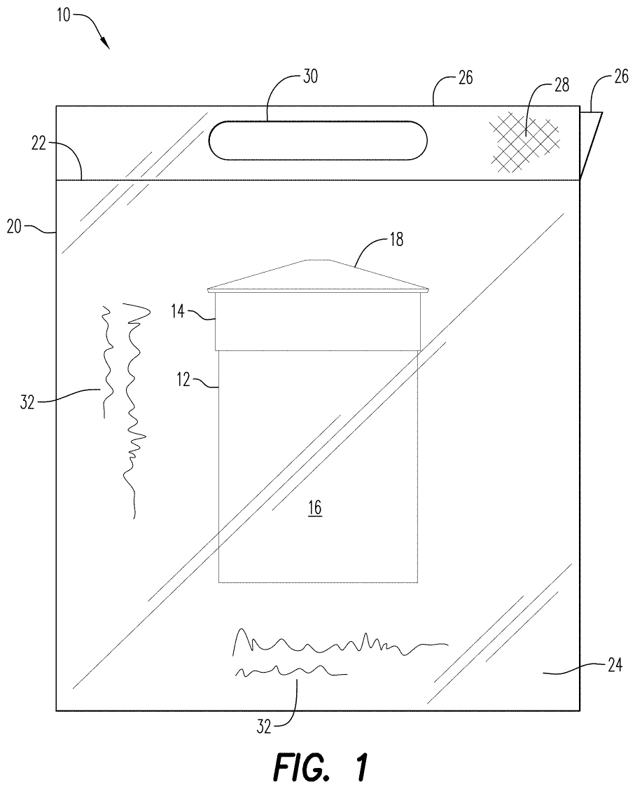

Referring now to the figures and in particular to FIG. 1, an exemplary embodiment of an exothermic reaction weld metal assembly according to the present disclosure is shown and is generally referred to by reference numeral 10. Advantageously, assembly 10 includes one or more consumables necessary for an exothermic weld in a simple, easy to use package that is sealed to prevent moisture from entering and any consumables from exiting.

Assembly 10 can include one or more of a tube 12, a cap 14, a weld metal 16, a metal disk 18, and an outer packaging 20. It should be recognized that assembly 10 is disclosed with respect to FIG. 1 with certain consumable materials but it is contemplated by the present disclosure for the assembly to include more or less items. In this manner, assembly 10 supplies the weld metal, discs, and optional accessories contained within an individually sealed package, which mitigates any misplacing of the required items.

Weld metal 16 is contained within tube 12 by cap 14 in a known manner. Weld metal 16 can include exothermic weld metal alone — or in combination with an ignition material.

In some embodiments, disk 18 can be removably secured to tube 12 or to cap 14. In other embodiments, disk 18 can be loose within outer packaging 20. In still other embodiments, disk 18 can also function as cap 14—namely the disk 18 can be used to close tube 12 so as to contain weld metal 16 in the tube.

Outer packaging 20 includes a seam 22 that defines a sealed area 24 around the tube 12, cap 14, and disk 18. Packaging 20 preferably impermeable to moisture including in liquid and/or gaseous form. In some embodiments, packaging 20 is configured so that sealed area 24 is a vacuum sealed area.

In some embodiments, packaging 20 formed of biodegradable materials. In this or other embodiments, tube 12 and cap 14 can also be formed of biodegradable materials. Here, assembly 10 can be used when welding components in a trench or underground — such that in the event that debris from the welding process (i.e., tube 12, cap 14, packaging 20) left in the ground will degrade naturally.

Assembly 10 can be configured to be openable by a user while wearing protective equipment, such as work gloves. For example, packaging 20 can include one or more gripping tabs 26 that allow the user to open the packaging and allow the contents to be removed.

Assembly 10 is shown in FIG. 1 having two opposing tabs 26, that allow the user to pull the tabs apart to open packaging 20. Tabs 26 can be located at seam 22 as shown in FIG. 1 such that the user pulls the tabs to separate seam 22 to open packaging 20 or in any desired portion of packaging 20.

Here, it is contemplated by the present disclosure for tabs 26 to have one or more grip enhancing structures. For example, tabs 26 can include one or more textured regions 28 configured to increase the gripability of the tabs. In this or other embodiments, tabs 26 can include one or more loops 30 that can receive one or more fingers of the user to increase the gripability of the tabs.

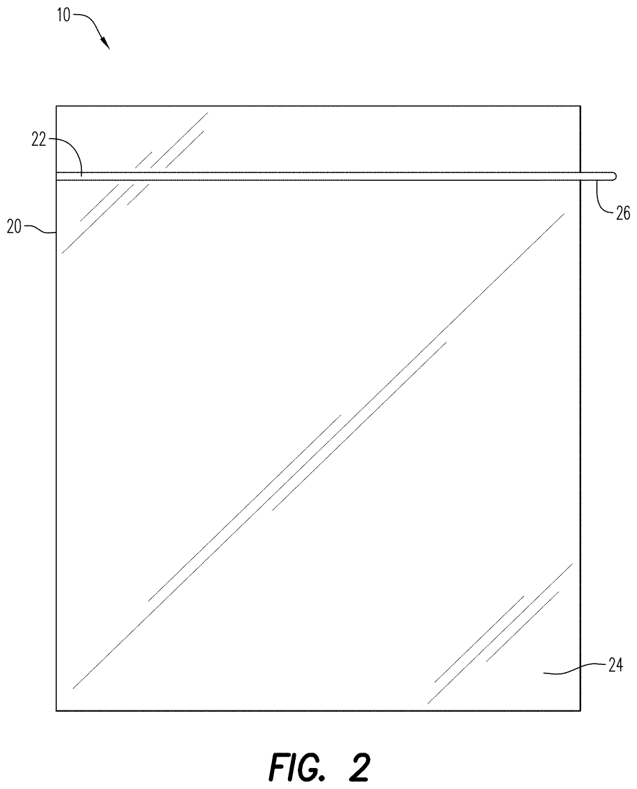

Of course it is contemplated by the present disclosure for assembly 10 to have more or less than two tabs 26. For example, assembly 10 is shown in FIG. 2 having a single tab 26. In this embodiment, tab 26 functions as a pull or tear strip. Tab 26 can be located at seam 22 as shown in FIG. 2 or in any desired portion of packaging 20.

Assembly 10 can include product information 32 such as but not limited to the batch number of the weld metal 16, the date the assembly was packed, the expiration date of the assembly, the usage instructions, the use by date, the formula of the weld metal, and any other desired information.

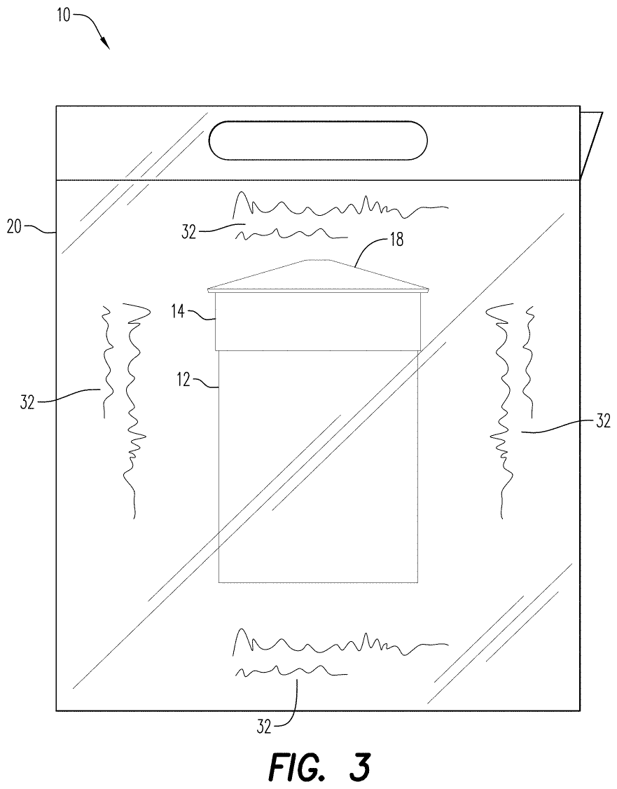

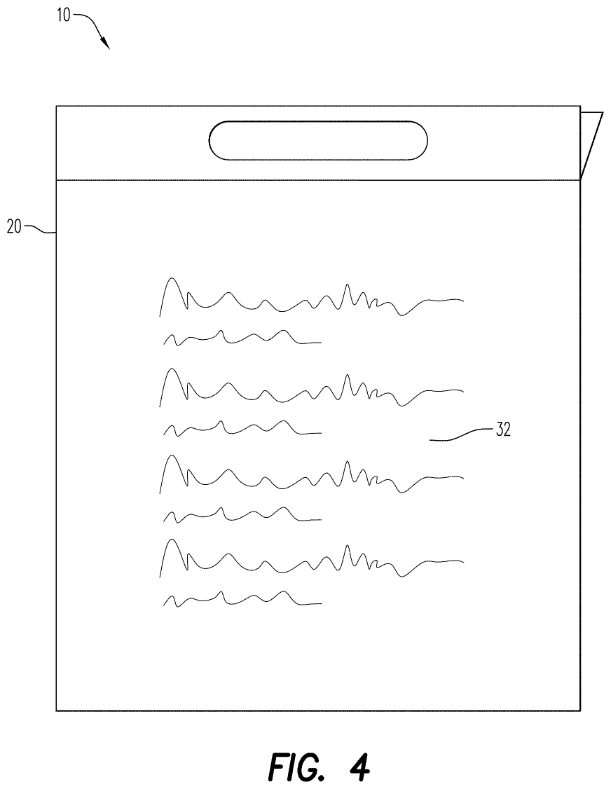

In some embodiments, product information 32 can be printed directly onto packaging 20. In addition or alternatively, product information 32 can be in the form of a product insert (not shown) within sealed area 24. Information 32 can be printed on the front (FIG. 3) of packaging 20, on the back (FIG. 4) of the packaging, on an inside wall of the packing, and any combinations thereof.

In addition or alternatively to product information 32 related to the useful life of assembly 10, the assembly can include a time expiring indicator on and/or in packaging 20.

Assembly 10 is shown in FIG. 1 as having packaging 20 defining a single sealed area 24 — containing one set of materials necessary for the exothermic welding process. In this embodiment, a plurality of the assemblies 10 can be packaged together in an additional container such as a box, a bag, and others.

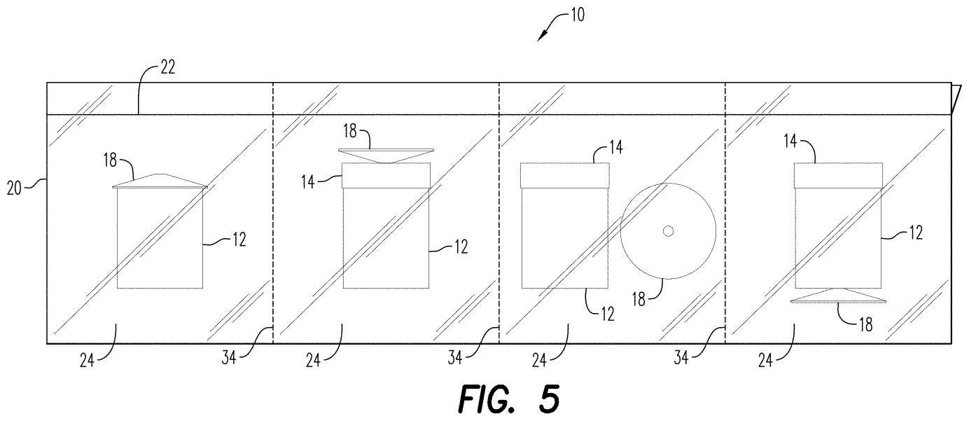

Assembly 10 is shown in FIGS. 5-7 having packaging 20 defining a plurality of sealed areas 24 that are removably connected to one another. Here, packaging 20 includes a tear line 34 between each sealed area 24. In this manner, assembly 10 is configured to allow the user to remove a single sealed area 24 by tearing along tear line 34.

As used herein, the term tear line 34 shall mean an area of weakness of packaging 20 that allows the user to separate one sealed area 24 from an adjacent sealed area 24. The area of weakness can be formed by one or more perforations, by one or more thinned regions, by one or more score lines and any other method of providing packaging 20 with tear line 34.

In FIG. 5, assembly 10 is shown having disk 18 in a number of different contemplated positions within sealed area 24. Specifically and moving from left to right in FIG. 5, disk 18 can be used in place of lid 14, can be secured to lid 14 in an inverted position, can be loose in sealed area 24, and can be secured to tube 12 in any desired orientation.

In FIG. 6, assembly 10 is shown including an igniting device 36 within each of the sealed areas 24. Here, igniting device 36 is shown in a number of different contemplated positions within sealed area 24. Specifically and moving from left to right in FIG. 6, igniting device 36 can be positioned above or below (phantom) tube 12 and lid 14, can be secured to tube 12 and/or lid 14, and can be positioned to the left or right (phantom) of tube 12 and lid 14.

It should be recognized that assembly 10 is shown in FIG. 6 by way of example as having no disk 18. Of course, it is contemplated by the present disclosure for assembly 10 to include disk 18 or to not include the disk.

In FIG. 7, assembly 10 is shown having packaging 20 with two tear lines 34 between two sealed areas 24. Here, the two tear lines 34 define a second area 24-1 in packaging 20. Second area 24-1 can be a sealed area or can be a permeable area. In this manner, assembly 10 can be configured to maintain some components (i.e., tube 12, lid 14, weld metal 16) in sealed area 24, and to maintain other components (i.e., disk 18 and igniting device 36) in second area 24-1. Here, disk 18 and igniting device 36 can be positioned in second area 24-1 in any desired orientation.

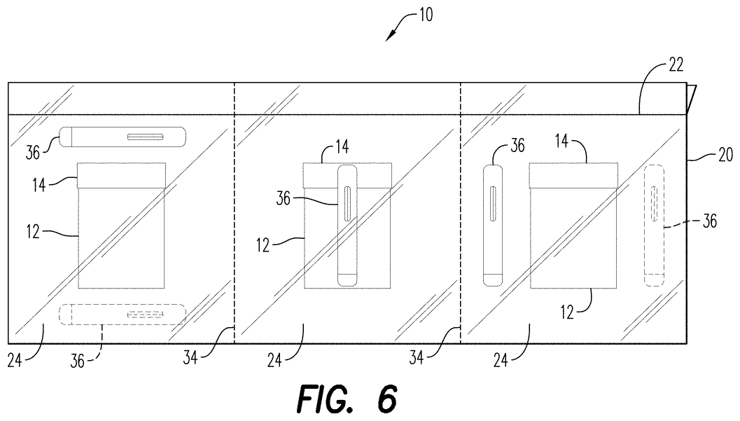

The use of assembly 10 is described with reference to FIGS. 8 and 9. Assembly 10 is shown before use in FIG. 8 and during the opening process in FIG. 9. Here, the user opens packaging 20 at seam 22 to allow access to the contents of sealed area 24. Once open, the user can remove weld metal 16, contained in tube 12 and lid 14, and disk 18 positioned on the lid as a single unit. Next, the user can remove disk 18 from lid 14 and can place the disk in the desired location in the mold. Finally, the user can open tube 12 by removing lid 14 allowing the user to pour weld metal 16 from the tube into mold and onto the disk 18.

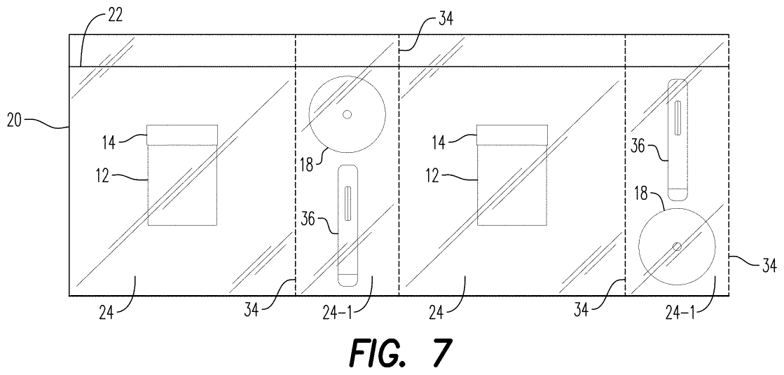

As discussed above, it can be desired in some embodiments for disk 18 to be secured to tube 12 and/or cap 14. Accordingly, FIGS. 10-14 illustrate alternate exemplary embodiments of disk retaining features 38 according to the present disclosure.

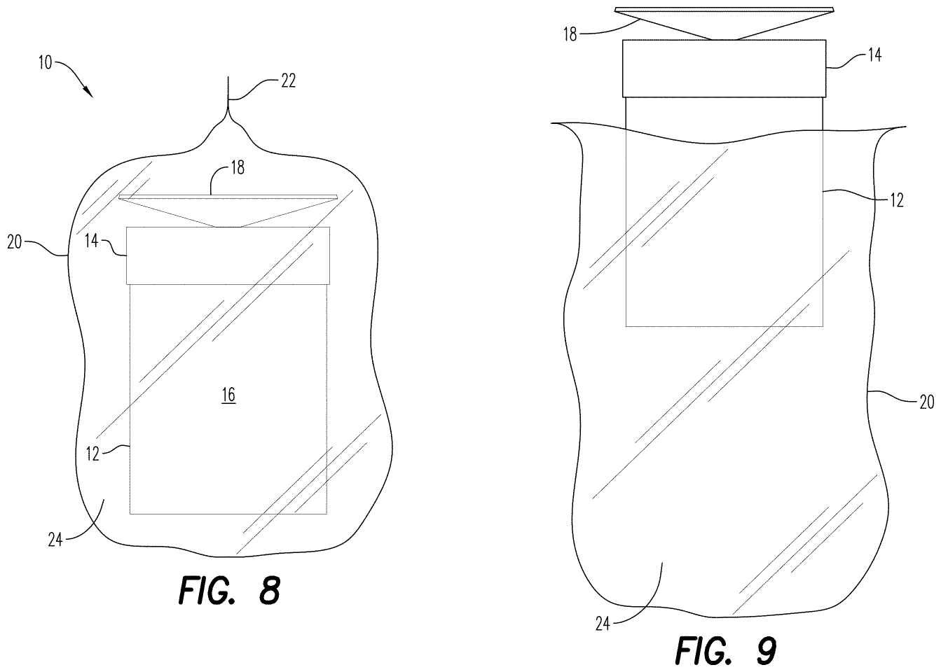

FIG. 10 shows a side view of disk retaining feature 38 and FIG. 11 shows a top view of FIG. 10. Here, lid 14 is illustrated having a plurality of bosses 40. Bosses 40 are sized and configured to form an interference fit with disk 18 in such a way that the disk is removably retained on lid 14.

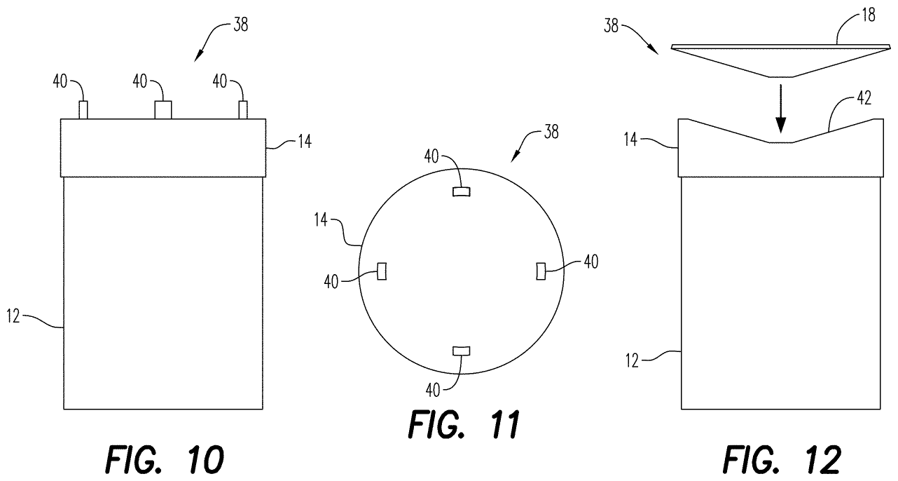

FIG. 12 shows a sectional view of an alternate embodiment of a disk retaining feature 38. Here, feature 38 is shown as a shaped region 42 defined in lid 14. Shaped region 42 is sized and configured to receive disk 18 in such a way that packaging 20—when vacuum sealed—holds the disk on lid 14 to the shaped region.

Shaped region 42 can be concave as illustrated in FIG. 12 such that the disk 18 is received in the shaped region. Alternately, shaped region 42 can be convex such that the disk 18 is received on the shaped region.

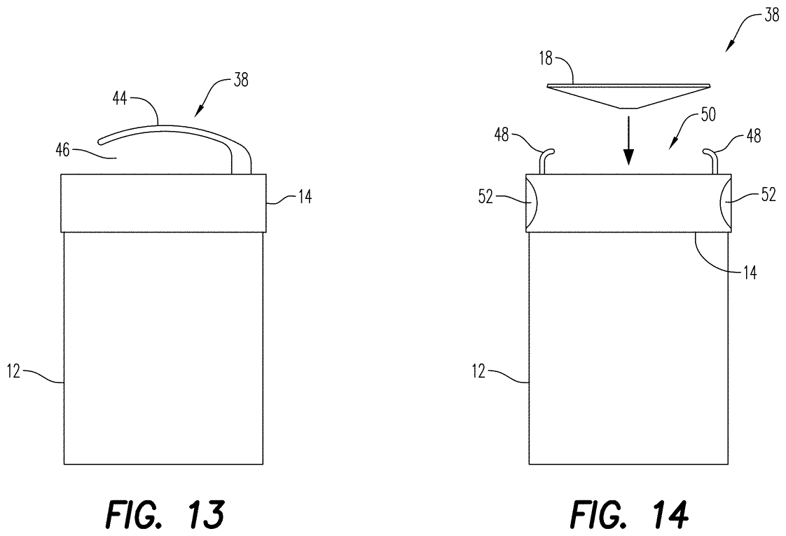

FIG. 13 shows a side view of disk retaining feature 38. Here, lid 14 is illustrated having clip 44. Clip 44 is sized and configured to deform upward as disk 18 in inserted into the opening 46 between the clip and lid 14 in a lateral direction such that the disk is removably retained on lid 14.

FIG. 14 shows a side view of disk retaining feature 38. Here, lid 14 is illustrated having a plurality of clips 48. Clips 48 is sized and configured to deform as disk 18 in inserted into the opening 50 between the clips in a vertical direction such that the disk is removably retained on lid 14.

It should be recognized that features 38 are shown by way of example only as being present on lid 14. Of course, it is contemplated by the present disclosure for features 38 to be present on tube 12, on lid 14, and on both the tube and the lid.

FIG. 14 also illustrates lid 14 having one or more finger gripping regions 52 to provide for more secure handling and easier removal of lid from tube 12.

Accordingly, assembly 10 can be sold in individual packages as in FIG. 1 or with a plurality of packages joined to one another with tear lines 34 as shown in FIGS. 5-7—allowing separation of a single unit as needed.

Sealed area 24—individually seals weld metal 16 to eliminate the bulk exposure problem with current packaging and provides a water proof seal to protect and extend the shelf life of the weld metal—and protects it from contamination in the field and during transport.

Additionally, the discs 18 and optional accessories (e.g., igniting device 36) can be contained within the individually sealed area 24 with each weld tube—or second area 24-1 separate by additional tear lines 34—to mitigate any misplacing of the required items. All the required consumable items for the welding process are contained in one sealed assembly 10. The assembly 10 is designed and configured so that it can be opened with weld/work gloves on.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

### REFERENCE NUMERALS

weld metal assembly 10
tube 12
cap 14
weld metal 16
metal disk 18
outer packaging 20
seam 22
sealed area 24
gripping tab 26
textured regions 28
loops 30
product information 32
tear line 34
igniting device 36
second area 24-1
disk retaining features 38
plurality of bosses 40
shaped region 42
clip 44
opening 46
plurality of clips 48
opening 50
finger gripping regions 52

What is claimed is:

1. A weld metal assembly, comprising:
a tube containing an exothermic reaction weld metal;
a metal disk; and
an outer packaging having a sealed area in which the tube and the metal disk are contained.

2. The assembly of claim 1, further comprising a cap on the tube so as to contain the weld metal in the tube.

3. The assembly of claim 2, wherein the metal disk is removably secured to the tube and/or the cap.

4. The assembly of claim 2, wherein the metal disk is loose within the outer packaging.

5. The assembly of claim 1, further comprising an igniting device in the sealed area.

6. The assembly of claim 1, wherein the weld metal further comprises an ignition material.

7. The assembly of claim 1, wherein the outer packaging has a feature selected from a group consisting of being vacuum sealed, being impermeable to moisture, being formed of biodegradable materials, and any combinations thereof.

8. The assembly of claim 1, wherein the outer packaging further comprises one or more gripping tabs configured for gripping by a user to open the outer packaging.

9. The assembly of claim 8, wherein the one or more gripping tabs comprises a pull or tear strip.

10. The assembly of claim 8, wherein the one or more gripping tabs comprises two opposing tabs that allow the user to pull the two opposing tabs apart to open the outer packaging.

11. The assembly of claim 10, wherein the two opposing tabs further comprise one or more grip enhancing structures.

12. The assembly of claim 1, further comprising product information on the outer packaging and/or in the sealed area.

13. The assembly of claim 1, wherein the outer packaging comprises a plurality of the sealed areas, each of the plurality of the sealed areas comprising the tube having the weld metal and the metal disk.

14. The assembly of claim 13, further comprising an igniting device in each of the plurality of the sealed areas.

15. The assembly of claim 13, wherein the outer packaging further comprises a tear line between the plurality of the sealed areas.

16. The assembly of claim 15, wherein the outer packaging further comprises two tear lines between the plurality of the sealed areas, the two tear lines defining a second area therebetween.

17. The assembly of claim 16, wherein the tubes are in the sealed area and the disks are in the second area.

18. The assembly of claim 17, wherein the igniting device is in the second area.

19. A method of using an exothermic reaction weld metal, comprising:
opening a sealed area of an outer packaging;
removing a tube containing an exothermic reaction weld metal and a metal disk from the sealed area; and
using the metal disk and the weld metal to form a weld.

20. The method of claim 19, wherein the outer packaging comprises a plurality of the sealed areas separated by a tear line, the method further comprising, prior to the opening step:
separating one of the plurality of the sealed areas from the outer packaging.
